(19) United States
(12) Patent Application Publication
(10) Pub. No.: US 2016/0253423 A1
(43) Pub. Date: Sep. 1, 2016

(54) DATA PROCESSING SYSTEM INCLUDING A SEARCH ENGINE

(71) Applicant: HEWLETT PACKARD ENTERPRISE DEVELOPMENT LP, Houston, TX (US)

(72) Inventors: Jerome Rolia, Kanata (CA); Wei-Nchih LEE, Palo Alto, CA (US); Wen Yao, San Diego, CA (US); Kevin Smathers, Hayward, CA (US)

(21) Appl. No.: 15/027,825

(22) PCT Filed: Oct. 31, 2013
(86) PCT No.: PCT/US2013/067679

§ 371 Date: Apr. 7, 2016

(51) Int. Cl. G06F 17/30

(52) U.S. Cl. CPC G06F 17/30867; G06F 17/3087; G06F 17/3051; G06F 17/30554

(57) ABSTRACT

A search engine receives a search trigger for a task. In response to identifying data that is responsive to the search trigger, a notification of the identified data is sent to the task, to cause the task to process the identified data. The search engine receives a notification of result data produced by the task based on the processing of the identified data.

### BACKGROUND

A data processing system can include analytic tasks for performing computations on data to produce results. Data from various sources can be provided to the analytic tasks for processing by the analytic tasks, Examples of different types of data include emails, web log files (which include log data of web activity), unstructured information including video data and audio data, structured data stored in database management systems, and so forth.

### BRIEF DESCRIPTION OF THE DRAWINGS

Some embodiments are described with respect to the following figures.

FIG. 1 is a block diagram of an example data processing system according to some implementations.

FIG. 2 is a flow diagram of a process of a data processing system, according to some implementations.

FIG. 3 is a schematic diagram of an example data processing system according to alternative implementations.

FIG. 4 is a schematic diagram showing analytic tasks and data objects of a data processing system, according to some implementations.

FIG. 5 is a block diagram of a data processing system according to some implementations.

### DETAILED DESCRIPTION

Analytic tasks in a data processing system can be developed by information technology (IT) personnel of an enterprise, such as a business concern, a government agency, an educational organization, and so forth. IT personnel can be familiar with certain types of data, which can aid the IT personnel when developing certain analytic tasks. An analytic task can refer to machine-readable instructions that are designed to provide specific functionalities. Examples of functionalities of analytic tasks include any of the following: clustering of data, applying a mathematic computation on data, performing a sentiment analysis on data, displaying data on a dashboard (which is a user interface configured to provide display of specific data), and so forth.

Analytic tasks can be arranged in a specific topology, where the output of one analytic task can be provided as an input to another analytic task. For example, a first analytic task can receive input data, and can apply processing on the input data to produce result data. The result data from the first analytic task can be sent to one or multiple other analytic tasks, and these other analytic task(s) can in turn produce further result data to be sent to additional analytic task(s). In some implementations, a topology of tasks can implement a continuous data-driven analysis, in which the analysis continues to perform its processing as further data is received.

The analytic tasks of a data processing system designed to process a large amount of data from many different types of data sources can collectively provide a big data application. The types of data that can be processed by such a big data application can include at least some of the following: structured data such as data stored in database management systems, semi-structured data such as emails and web log files that contain log data for web activity, and unstructured data such as video data, audio data, text postings, and so forth.

Implementing a data processing system that includes a wide variety of analytic tasks that can process a wide variety of data types can be complex. Traditionally, to develop analytic tasks of a data processing system, IT personnel would have to have specialized knowledge of the schema, formats, and locations of the various different types of data that are to be processed by the analytic tasks. Moreover, analysts who are familiar with the analytic functionalities of analytic tasks may have to interact with IT personnel to make sure that the analysts obtain the correct data. The foregoing issues can slow down development of the analytic tasks, especially if there is an insufficient number of IT personnel assigned to development of the analytic tasks, or if the IT personnel is unfamiliar with the schema and formats of certain data types. A schema defines the structure and attributes of data. A format refers to the general form in which the data is presented.

In addition, gathering data for specific analysis by a given analytic task can be time consuming, error prone, and may lack consistency across analytic exercises. IT personnel may not know of all sources of data that may be relevant to a specific analytic task. Moreover, IT personnel may not be aware that result data produced by a first analytic task may be of interest in the analysis that is being performed by a second analytic task, In some cases, a large amount of time may be wasted on repeating certain data processing efforts that are performed to enable analysis by analytic tasks, where such data processing efforts can include data cleaning, data filtering, and data transformation, as examples.

In addition, new data may be received or may be generated that may be of interest to certain analytic tasks. Attempting to identify all relevant data (existing data as well as data that may be newly received or generated) that is to be processed by a given analytic task may be impractical, especially in a large data processing system.

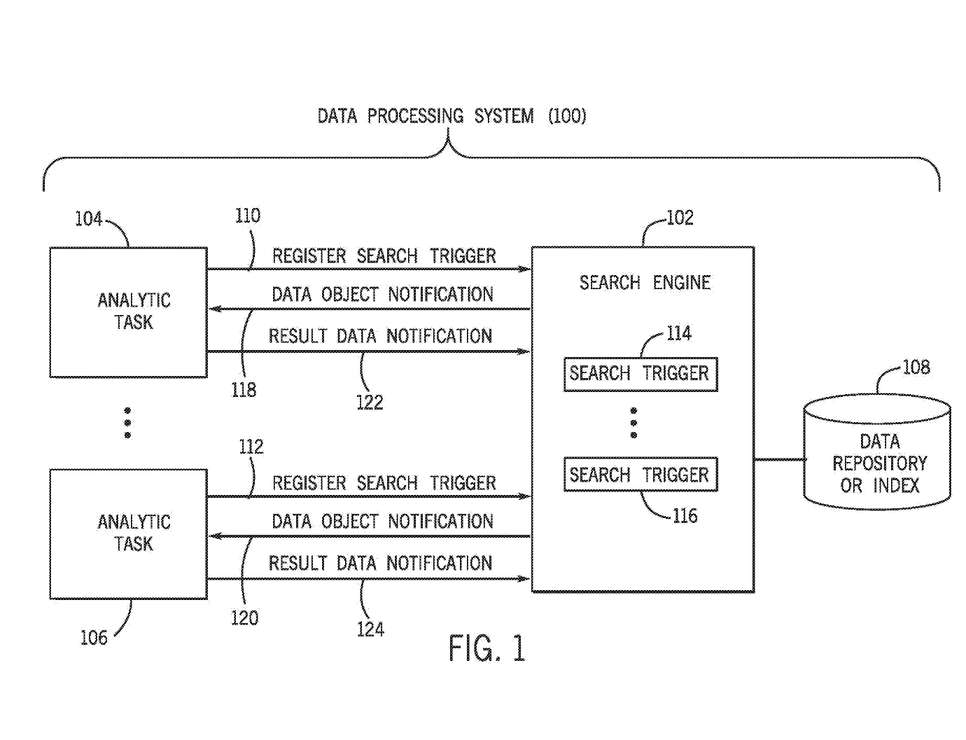

In accordance with some implementations, a search engine-based data processing system is employed to allow for identification of data to be processed by analytic tasks in the data processing system. An example data processing system 100 shown in FIG. 1 includes a search engine 102 and various analytic tasks 104 and 106. Although just two analytic tasks are shown in FIG. 1, it is noted that the data processing system 100 can include more than two analytic tasks.

A search engine refers to an entity that is able to receive a search request that specifies one or multiple criteria relating to data of interest. In response to the search request, the search engine 102 accesses a data repository or index 108 to identify data objects that match the search criterion or criteria of the search request. A data object can refer to any unit of data, such as a file, an image, a collection of video data, a collection of audio data, a tuple, and so forth.

A data repository refers to a repository that stores data objects. A data index refers to a data structure that maps attribute values to references to data objects that contain the attribute values. A reference to a data object can specify a location of the data object. For example, a reference to the data object can be in the form of a Uniform Resource Locator (URL) or some other location identifier.

In an example, data objects can include multiple attributes, including a first attribute, a second attribute, and so forth. An index can map different values of the first attribute (or a combination of attributes) to references to data objects. An index can be used by the search engine 102 to more quickly locate data object(s) that match(es) the search criterion (or criteria) of a search request.

The search engine 102 can be web search engine that can be responsive to web search requests. Alternatively, the search engine 102 may be a database management engine that is able to receive database queries, and in response, to retrieve data from a database that includes relational data.

As shown in FIG. 1, the analytic tasks 104, 106 can register (110, 112) search triggers with the search engine 102, which stores search trigger information 114 and 116. The search trigger information 114 or 116 includes information relating to a respective registered search trigger. A search trigger can include one or multiple search requests. A registered search trigger indicates to the search engine 102 an entity (e.g. an analytic task) that is interested in data objects responsive to the search request(s) of the registered search trigger.

The search trigger information 114, 116 can include a description of the search request (or requests) of interest to a respective analytic task. The description of the search request(s) can specify the one or multiple search criteria against which data is to be matched.

As new data is received by the search engine 102, the data repository or index 108 can be updated. For example, the new data can be stored in the data repository, or alternatively, an entry in the index can be added for the new data.

As the search engine 102 identifies a data object that is responsive to a respective search trigger, a notification of the identified data object can be sent (118, 120) to the analytic task 104 or 106 that registered the search trigger. The notification can include the identified data object, or alternatively, a reference to the identified data object.

The respective analytic task 104 or 106 that receives the notification (118, 120) can retrieve the identified data object, and can process the identified data object. For example, the analytic task can perform a computation based on the identified data object, or the analytic task can perform another operation in response to content of the identified data object. Result data is produced as a result of the processing by the analytic task.

The analytic task 104 or 106 sends (122, 124) a notification of the result data back to the search engine 102. The search engine 102 can store information pertaining to the result data in the data repository or index 108. For example, the result data can be stored in the data repository, or an entry corresponding to the result data can be added to the index.

Note that the result data may be of interest to other analytic tasks, based on matching to respective search triggers at the search engine 102. If the search engine 102 determines that the result data is responsive to a search trigger, as expressed by any of the search trigger information 114, 116, then the search engine 102 can send a notification of the result data to the respective analytic task.

A notification (122, 124) of result data sent by an analytic task 104 or 106 to the search engine 102 can include various metadata, such as any or some combination of the following: a subject of the result data in the result object, where the subject can refer to some user or system-provided short description relating to the result data; information relating to the processing performed, where the information relating to the processing that has been performed can be according to a specified taxonomy (which identifies various categories or concepts); a version of the processing that is performed; a time associated with the processing; a reference to the result data along with metadata that describes a location and format of the result data; and a list of references to data objects that contributed to the processing performed by the analytic task.

The list of object references to data objects that contributed to the processing performed by the analytic task identifies those input data objects that contain data used by the analytic task to perform its computation or operation. This list of object references to data objects that contributed to the processing by the analytic task is also referred to as the provenance of result data produced by the analytic task. The provenance documents a trace of data objects that contributed to the processing by the analytic task, and the provenance can assist IT personnel and business analysts in better understanding, analysis, and debugging of the analytic task.

By using techniques or mechanisms according to some implementations, an analytic task can be automatically notified as new data objects become available, such that the analytic task can proceed with further processing. The new data objects can be newly received by the data processing system, or the new data objects may be newly generated by one or multiple analytic tasks in the data processing system. New data objects may include data of a new type that previously did not exist in the data processing system. Using techniques or mechanisms according to some implementations, IT personnel does not have to manually identify data objects of interest to a given analytic task.

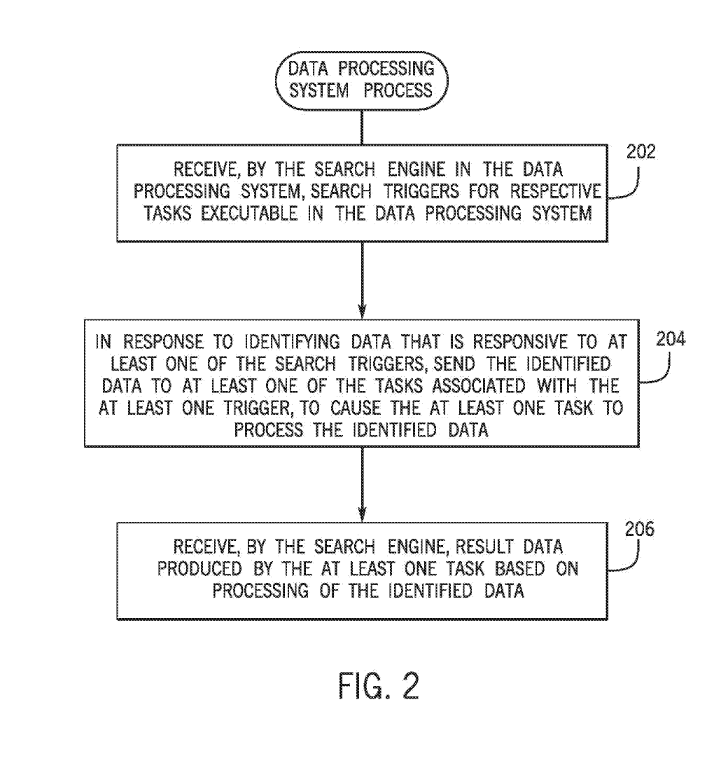

FIG. 2 is a flow diagram of a process of the data processing system 100 according to some implementations. The search engine 102 in the data processing system 100 receives search triggers for respective tasks (e.g. the analytic tasks 104, 106 in FIG. 1) that are executable in the data processing system 100.

In response to identifying data that is responsive to at least one of the search triggers, the data processing system 100 sends (at 204) a notification of the identified data to at least one of the tasks associated with the at least one trigger, to cause the at least one task to process the identified data. Note that the sending of the notification (at 204) can be performed by the search engine 102, or by another entity. For example, the search engine 102 can notify the other entity (which can be an analytic task or some other entity), that the notification of the identified data is to be sent by the other entity to the at least one task associated with the at least one trigger.

The search engine 102 receives (at 206), from the at least one task, a notification of result data produced by the at least one task based on processing of the identified data.

Techniques or mechanisms according to some implementations also allow for more flexible development of analytic tasks. Traditionally, an enterprise relies upon IT personnel with specific expertise to develop analytic tasks for a data processing system. However, this can lead to a bottleneck in the development of analytic tasks, particularly if an insufficient number of IT personnel is assigned.

In accordance with some implementations, business contributors can also be involved in creating analytic tasks. A business contributor can refer to any person that is involved in execution of a data processing system. This business contributor may not have any specific knowledge regarding schemas, formats, or locations of data from various types of data sources. However, by using the search engine-based data processing system 100, a business contributor can easily create a new analytic task along with one or multiple search triggers to specify data that is of interest to the newly created analytic task. The data of interest to the newly created analytic task can then be automatically sent to the newly created analytic task, based on the search trigger(s) registered by the newly created analytic task.

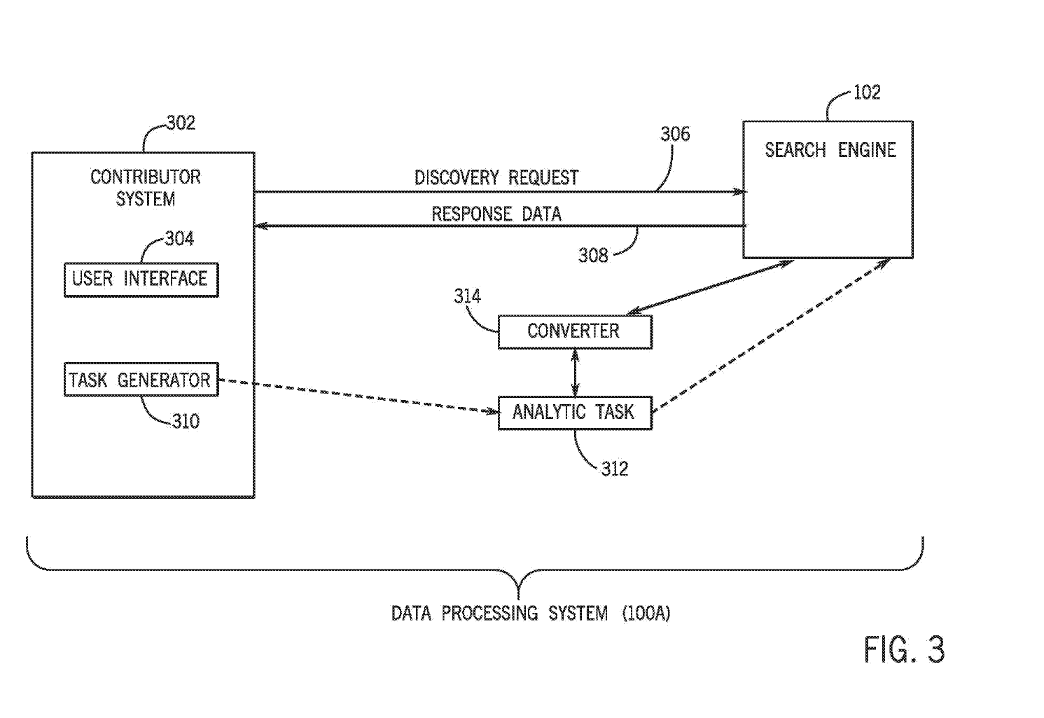

An example of a data processing system 100A according to further implementations is shown in FIG. 3. The data processing system 100A includes a contributor system 302 and the search engine 102. The contributor system 302 includes a user interface 304, which can be a web browser or other type of user interface. Using the user interface 304, a business contributor can submit a discovery request 306 to the search engine 102, to discover data that describe analytic tasks and results of the analytic tasks. In response to the discovery request 306, the search engine 102 sends response data 308 to the contributor system 302, which presents information relating to analytic tasks and results of analytic tasks in the user interface 304. By using the discovery process according to some implementations, the business contributor may determine that the data processing system 100A does not include analytic tasks that produce results that are desired by the business contributor.

In such a scenario, the business contributor can use a task generator 310 in the contributor system 302 to generate a new analytic task 312. For example, the task generator 310 can include MICROSOFT® EXCEL, which can be used to generate an analytic task in the form of an EXCEL spreadsheet. In other examples, other tools can be used to generate analytic tasks,

Also, the business contributor can use the contributor system 302 to develop one or multiple search triggers for the new analytic tasks 312, where these new search trigger(s) can be registered with the search engine 102 to specify the search criterion (or criteria) of interest to the newly created analytic task. For example, the business contributor can enter search criterion or criteria into the user interface 304 for the search trigger(s). The user interface 304 can submit the entered search criterion or criteria to the search engine for registration as search trigger(s).

Following registration of a search trigger, further operations as discussed above in connection with FIGS. 1 and 2 can be performed by the data processing system 100A.

FIG. 3 further shows a converter 314 that is associated with the new analytic task 312. The converter 314 can translate from the schema or format of the data provided by the search engine 102, to the schema or format of data expected by the analytic task 312. Similarly, the converter 314 can translate from the schema or format of data provided by the analytic task 312, into a schema or format expected by the search engine 102.

In some examples, the converter 314 can be a Real Time Data Server (RTDS) component as implemented using Microsoft technologies. In other examples, the converter 314 can be a different type of converter. Such converters also enable updates to the contributor system 302 as notifications arrive from the search engine 102, and as triggers are registered.

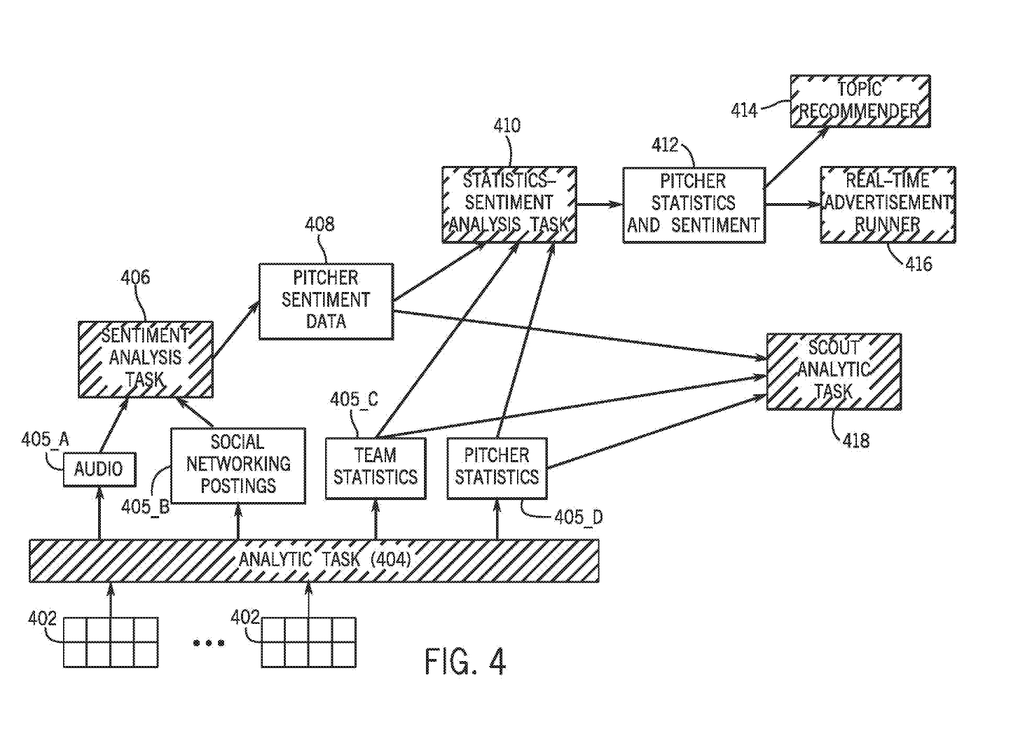

FIG. 4 is a schematic diagram illustrating various analytic tasks as well as data objects. Source data objects 402 are provided from various data sources to a data processing system that includes analytic tasks 404, 406, 410, 414, 416, and 418, as examples. The analytic tasks shown in FIG. 4 are related to processing relating to a professional baseball team.

The analytic task 404 receives the source data objects 402, and produces additional data objects 405_A, 405_B, 405_C, and 405_D based on the source data objects 402. The data object 405A includes audio data, the data object 405_B includes social network postings, the data object 405_C includes team statistics, and the data object 405_D includes pitcher statistics.

The processing by the analytic task 404 can add metadata to the source data objects 402. For example, the metadata can be keywords and concepts produced by the analytic task 404, where the keywords and concepts can be used for performing searches or other operations on data objects.

The data objects 405_A and 405_B are provided as input to a sentiment analysis task 406, which is another analytic task. The sentiment analysis task 406 produces output data 408 describing sentiments expressed by fans of pitchers on the team.

The pitcher sentiment data 408 along with team statistics data object 405_C and pitcher statistics data object 405_D can be provided to statistics-sentiment correlation task 410, which is another analytic task. The statistics-sentiment correlation task 410 performs a correlation between pitcher statistics and pitcher sentiment. The statistics-sentiment correlation task 410 outputs result data 412 that correlates pitcher statistics to sentiment.

The result data 412 can be provided to a topic recommender 414 and a real-time advertisement runner 416, which are additional analytic tasks. The topic recommender 414 can recommend topics to be covered by a color commentator of a baseball game based on the result data 412. The advertisement runner 416 can produce real-time advertisements that should be run (on a website or in a television broadcast of the baseball game) based on the result data 412.

In addition, the output data 408 describing sentiments regarding pitchers, along with the team statistics data object 407 and pitcher statistics data object 408, can be provided to a scout analytic task 418, which can be used to perform analysis regarding the scouting of pitchers.

It can be seen that the analytic tasks in FIG. 4 are related to each other in a specific topology. The topology can be implied from the search triggers registered by the respective analytic tasks. For example, the analytic task 406 may have registered search triggers for the audio data 405_A and social network postings 405_B produced by the analytic task 404. Similarly, the analytic task 410 may have registered a search trigger for the result data 408 produced by the analytic task 406. In this way, the data processing system can determine, based on the registered search triggers, the relationships among the analytic tasks in the data processing system. Based on the determined relationships, the data processing system can generate the topology of the analytic tasks.

The determination of the topology can be performed by the contributor system 302 of FIG. 3. In addition, the contributor system 302 can display the topology of the analytic tasks in the user interface 304, which can assist a business contributor in better understanding relationship of various analytic tasks. For example, the business contributor may be thinking about modifying or removing a particular analytic task. Prior to making such modification or removal, the business contributor can view the topology of analytic tasks, to see what other analytic tasks may be impacted by the modification or removal.

As noted above, metadata can be included in a notification of result data from an analytic task. Such metadata can be stored by the search engine 102 (FIG. 1) in the data repository or index 108 in association with the respective result data. By storing such metadata, the search engine 102 can be used to support a concept-aware search based on the metadata.

Such a search based on the metadata can be referred to as a concept-aware search, since it is a search that employs metadata associated with data objects stored by the search engine 102. The concept-aware search can allow further analysis to be performed on the way result data of analytic tasks are being used. An example of a concept-aware search is provided below. Suppose there are N different analytic applications each supported by a topology of analytic tasks. If some subset n of the N analytic applications rely on a particular analytic task t, then the subset of n analytic applications may be considered to be conceptually related. Assume further that a given application uses analytic task t. A concept-aware search can be performed for other applications that are similar to the given application. Such other applications are those that may rely on the particular analytic task t. The more tasks the applications have in common the more related they may be. Further, the concept-aware search can use other metadata stored with result data produced by each of the analytic tasks to further rank the strength of the conceptual relationship.

Additionally, the user interface 304 of the contributor system 302 can be used to display the provenance of a given analytic task (or a combination of analytic tasks). As noted above, the provenance of an analytic task documents a trace of data objects that contributed to the processing by the analytic task. The displayed provenance can assist IT personnel and business analysts in better understanding, analysis, and debugging of the analytic task.

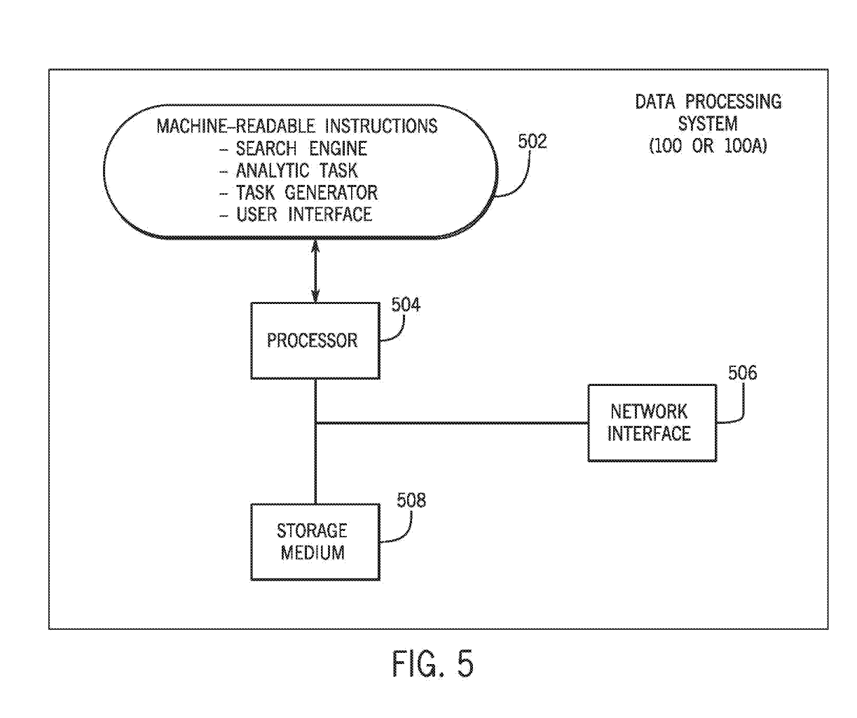

FIG. 5 is a block diagram of an example data processing system 100 or 100A. The data processing system 100 or 100A can include a computer system, or multiple computer systems. The data processing system includes machine-readable instructions 502, which are executable on one or more processors 504. The machine-readable instructions can include instructions of the search engine 102, analytic tasks, task generator 310, and user interface 304, discussed above.

The processor(s) 504 can be connected to a network interface 506 and a storage medium (or storage media) 508. A processor can include a microprocessor, microcontroller, processor module or subsystem, programmable integrated circuit, programmable gate array, or another control or computing device. The network interface 506 allows the data processing system 100 or 100A to communicate over a data network, and the storage medium (or storage media) 508 stores various data, such as the data repository or index 108, and the search trigger information 114, 116.

The storage medium (or storage media) 508 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes, Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that he appended claims cover such modifications and variations.

What is claimed is:

1. A method comprising:
receiving, by a search engine in a data processing system including a processor, search triggers for respective tasks executable in the system;
in response to identifying data that is responsive to at least one of the search triggers, causing, by the search engine, sending of a notification of the identified data to at least one of the tasks associated with the at least one search trigger, to cause the at least one task to process the identified data; and
receiving, by the search engine, a notification of result data produced by the at least one task based on the processing of the identified data.

2. The method of claim 1, further comprising:
updating, by the search engine, an index based on the result data.

3. The method of claim 2, further comprising:
determining, by the search engine using the updated index, that the result data is responsive to a second of the search triggers; and
sending, by the search engine, a notification of the result data to a corresponding one of the tasks associated with the second search trigger.

4. The method of claim 1, further comprising:
receiving, by the system, a new task created by a user; and
registering, by the system, a search trigger for the new task with the search engine.

5. The method of claim 1, further comprising:
determining a topology of the tasks based on relationships determined from the search triggers.

6. The method of claim 5, wherein the relationships are indicated by the search triggers indicating which task has registered an interest in result data from another of the tasks.

7. The method of claim 5, further comprising:
displaying the topology of the tasks in a user interface.

8. The method of claim 1, further comprising:
displaying a provenance of a particular task in a user interface, the provenance identifying object references to data objects that contributed to processing performed by the particular task.

9. The method of claim 1, further comprising:
converting, using a converter, between a schema of data provided by the search engine and a schema of data provided by one of the tasks.

10. A data processing system comprising:
at least one processor;
an analytic task executable by the at least one processor to:
register a search trigger with a search engine of the data processing system;
receive, from the search engine, a notification of data responsive to the search trigger;
process the data to produce result data; and
send, to the search engine, a notification of the result data, to cause the search engine to store information associated with the result data.

11. The system of claim 10, wherein the data responsive to the search trigger is produced by another analytic task in response to notification of data provided by the search engine to the another analytic task.

12. An article comprising at least one non-transitory machine-readable storage medium to store instructions that upon execution cause a data processing system to:
receive, by a search engine in the data processing system, search triggers for respective tasks executable in the system;
in response to identifying data that is responsive to a first of the search triggers, send a notification of the identified data to a first of the tasks associated with the first search trigger, to cause the first task to process the identified data;
receive, by the search engine, a notification of result data produced by the first task based on the processing of the identified data;
determine, by the search engine, that the result data is responsive to a second of the search triggers; and
send, by the search engine, a notification of the result data to a second of he tasks associated with the second search trigger.

13. The article of claim 12, wherein the instructions upon execution cause the system to further:
update an index based on receiving the result data,
wherein the determining that the result data is responsive to the second search trigger uses the updated index.

14. The article of claim 12, wherein instructions upon execution cause the system to further:
determine, based on relationships indicated by the search triggers, a topology of the tasks, wherein the topology of the tasks indicate which tasks are related to which other tasks.

15. The article of claim 12, wherein identifying the data that is responsive to the first search trigger includes identifying a new type of data not previously present in the system.
